(19) United States
(12) Patent Application Publication
(10) Pub. No.: US 2016/0000058 A1
(43) Pub. Date: Jan. 7, 2016

(54) Tattle Tail Bobber Device and Method of Using the Same

(71) Applicant: Toby W. Savage, Urbana, OH (US)

(72) Inventor: Toby W. Savage, Urbana, OH (US)

(21) Appl. No.: 14/754,943

(22) Filed: Jun. 30, 2015

Related U.S. Application Data
(60) Provisional application No. 62/021,377, filed on Jul. 7, 2014.

(51) Int. Cl. A01K 97/12; A01K 99/00; A01K 91/06

(52) U.S. Cl. CPC A01K 97/12; A01K 91/06; A01K 99/00

(57) ABSTRACT

The present invention provides a fishing alert device, referred to as a “tattle tail bobber,” and method, which rapidly signals a fisher that a fish is biting on bait or is hooked on their fishing line. Unlike conventional bobbers used in fishing, the tattle tail bobber device of the present invention is not placed on or in the water, but is attached to a fishing line and is suspended above a water source in order to provide immediate notice to a fisher of a catch, even when the fisher is not in contact with a fishing rod or is at a distance from the fishing rod. The tattle tail bobber accomplishes this by being configured to glow in the dark. Thus, the tattle tail bobber can be used at any time of the day or night without the need to use batteries or other light sources.

### CROSS REFERENCE TO RELATED APPLICATIONS

The present application claims priority to U.S. Provisional Application No. 62/021,377, filed Jul. 7, 2014, which is incorporated herein by reference.

### FIELD OF THE INVENTION

The present invention relates to fishing equipment and, in particular, to a fishing alert device and method which signals to fishermen and fisherwomen that a fish is biting on bait or is hooked on their fishing line.

### BACKGROUND OF THE INVENTION

A bobber, also called a float, is an item of angling, i.e., fishing, equipment that attaches to a fishing line and serves several purposes for the fisher: it floats on top of the water so that bait can be suspended at a predetermined depth below the water so that bait does not touch the bottom of the water; it keeps bait at eye level of fish; it can carry a baited hook to otherwise inaccessible areas of water by its ability to drift in the prevailing current; and it can serve as a visual bite indicator. Usually, the line between the bobber and hook will have small weights attached thereon, ensuring that the float sits vertically in the water. Conventional bobbers, therefore, are designed to be buoyant so that they are able to float on water.

In order to alert a fisher that a fish has been caught on their fishing line, conventional bobbers require that the fisher remain by their fishing rod and continuously view the tip of the rod to see if a fish has been caught. Further, if fishing after dark, the bobbers require a light source, such as a battery, to view the fishing rod. Still further, fishers who fish on the bottom of a water source need to hold their fishing rod to be able to view the tip of the rod or, alternatively, lock the fishing rod into a pole holder, which hinders using a jerking motion to hook a fish.

There exists a need, therefore, for an improved fishing alert device that overcomes the limitations of the prior art.

### SUMMARY OF THE INVENTION

The present invention fulfills this need by providing a glow-in-the-dark angling, or fishing, alert device, referred to herein as a “tattle tail bobber,” and an improved method of fishing using the tattle tail bobber.

The tattle tail bobber device of the present invention is a fishing alert device which signals to fishermen and fisherwomen (referred to herein as “fishers”) that a fish is biting on bait on a fishing line or is hooked on the fishing line. The tattle tail bobber may be used by fishers fishing underneath the surface of all bodies of water, including without limitation, ponds, canals, lakes, streams, rivers and oceans.

Unlike conventional bobbers used in fishing, the tattle tail bobber device of the present invention is not placed on or in the water, but is attached to a fishing line and is suspended above the water in order to provide immediate notice to a fisher of a catch. The tattle tail bobber accomplishes this by being configured to glow in the dark. Thus, the tattle tail bobber may be used at any time of the day or night without the need to use batteries or solar cells for lighting purposes. This provides fishers with an economic way to fish, since they do not need to purchase glow sticks, flashlights or lanterns, which can be quite costly.

In an aspect of the invention, there is provided a device for fishing, comprising a fishing alert device referred to as a tattle tail bobber, said tattle tail bobber having a first end and a second end, said tattle tail bobber containing a glow-in-the-dark material; and a first attachment means attached to the first end and a second attachment means attached to the second end, wherein the first and the second attachment means each have a curved portion which curves in opposite directions from one another, wherein the first and the second attachment means are configured to accept a fishing line within their curved portions, said fishing line able to slide easily within the opposing curved portions of the first and the second attachment means.

In another aspect of the invention, there is provided an improved method of fishing, comprising the steps of casting a fishing line into a water source with the use of a fishing rod; placing a fishing alert device referred to as a tattle tail bobber which contains a glow-in-the-dark material on the fishing line between two eyelets located on the fishing rod; pulling downwardly on the tattle tail bobber in order to decrease slack of the fishing line, said tattle tail bobber suspended above the water source; having the tattle tail bobber move upwardly when a fish bites on the fishing line, said upward movement due to the fish pulling downwardly on the fishing line, said downward movement tightening the fishing line; and a user viewing the upwardly moving tattle tail bobber which rapidly alerts the user that a fish has bitten on the fishing line, which allows the user to react rapidly to secure the fish on a hook of the fishing line.

Unlike conventional bobbers, the tattle tail bobber of the invention is suspended above the water and never rests on top of the water or enters the water. Thus, the tattle tail bobber need not be buoyant in water, although the invention encompasses tattle tail bobbers that may be buoyant in water.

The tattle tail bobber of the invention can have a wide variety of shapes and likenesses which include, without limitation, shapes such as ovoid, square, rectangular, cylindrical and round; and likenesses such as fish, animals, boats, famous landmarks, sports medallions, toys and the like.

Any suitable manufacturing method can be employed so that the tattle tail bobber of the invention contains glow in the dark material, such as, without limitation, coating or painting the tattle tail bobber with glow in the dark material, combining glow in the dark material in an injection mold of the tattle tail bobber, or placing glow in the dark material in a hollow cavity of the tattle tail bobber. Such glow in the dark material allows a user to easily see the tattle tail bobber while fishing after dark, without the need to have a battery-operated or other light source.

Any suitable material may be used to manufacture the tattle bobber of the invention, such as, without limitation, plastics, rubbers and acrylics.

The tattle tail bobber of the invention can have a weight which ranges anywhere between about 0.1 ounce and about 8.0 pounds.

### BRIEF DESCRIPTION OF THE DRAWINGS

A fuller understanding of the invention can be gained from the following description when read in conjunction with the accompanying figures, where like reference numerals refer to identical or functionally similar elements throughout the separate views, which illustrate some, but not the only and exclusive, examples of embodiments of the invention and, as such, the figures disclosed herein are to be considered illustrative rather than limiting. In the drawings:

FIG. 1 is an illustration of the tattle tail bobber device of the invention hanging from a fishing line of a fishing rod in accordance with an embodiment of the invention; and

FIG. 2 is a perspective view of the tattle tail bobber device in accordance with an embodiment of the invention.

### DETAILED DESCRIPTION OF THE INVENTION

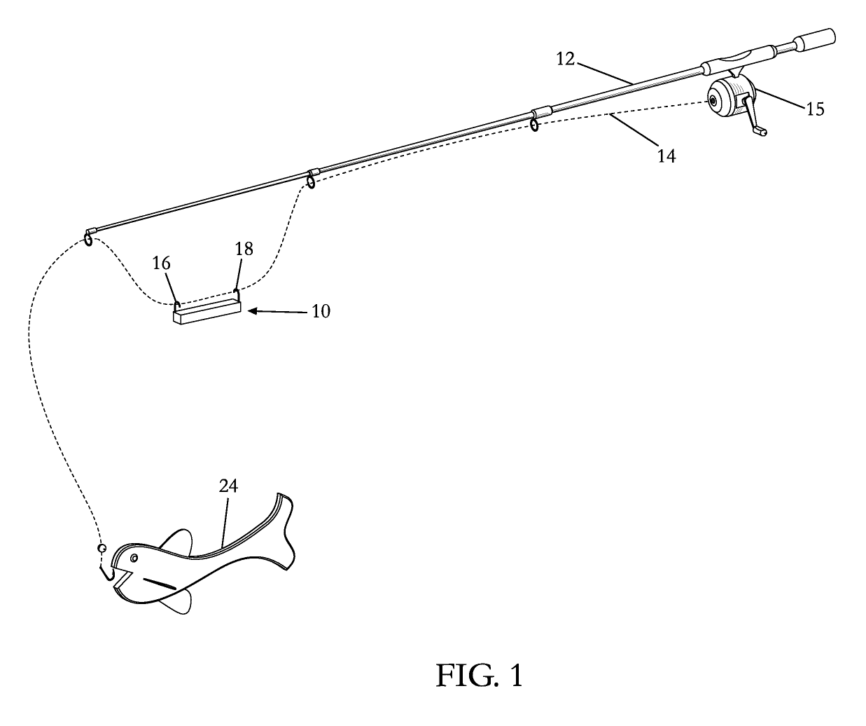

Referring to the figures, FIG. 1 shows a non-limiting embodiment of the tattle tail bobber 10 of the invention when hooked onto a fishing line 14 of a fishing pole 12. The tattle tail bobber 10 shown in FIG. 1 is rectangular in shape, but may be any shape or likeness, such as without limitation, circular, square, cylindrical, or ovoid; or designed to look like a fish, a boat, a sports medallion, a famous landmark, or any other shape or likeness desired by a fisher.

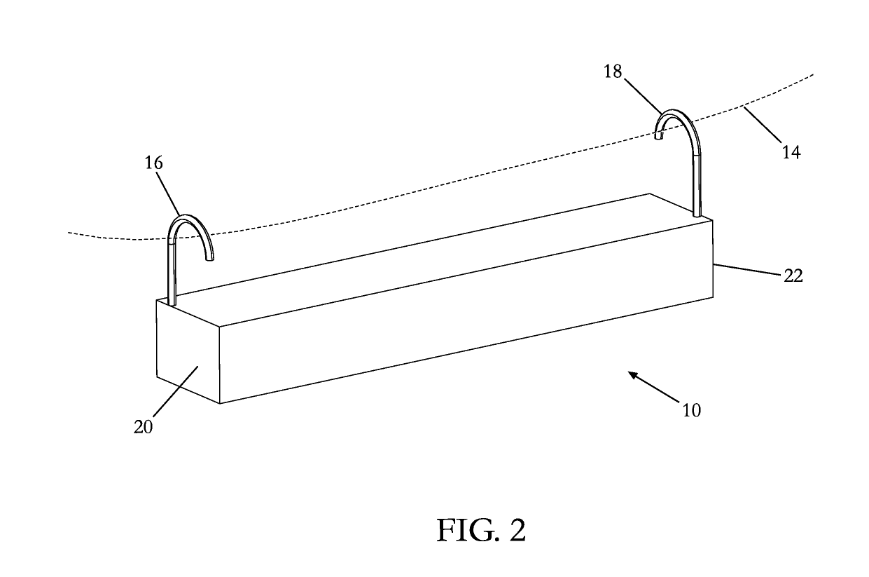

As shown in FIG. 2, the tattle tail bobber has a first hook 16 and a second hook 18 attached to the first end 20 and the second end 22 of the tattle tail bobber 10, respectively. The two hooks 16, 18 have an entry slot which allows for the fishing line 14 to slide through the hooks without effort. The hooks 16, 18 allow for any size fishing line to be used. The hooks 16, 18 have a curvature so that the tattle tail bobber 10 hangs down from the fishing line securely. In accordance with the invention, the hooks 16, 18 may be faced in opposite directions so that if one hook becomes detached from the fishing line, the other hook still is attached.

The device of the present invention may be constructed from any suitable material, such as, without limitation, plastics, rubbers, acrylics and the like. The material is manufactured to glow in the dark by applying “glow in the dark” paint over the material during the manufacturing process, mixing and/or combining the glow in the dark paint in an injection mold of the device, or hollowing out the tattle tail bobber and filling the hollowed-out portion with glow in the dark material.

Glow in the dark paints and processes are well known in the art. For example, the tattle tail bobber may be sprayed or dipped with glow in the dark adhesive during manufacturing. The glow in the dark material may be of any suitable color. For example, locksmith rods are coated with a glow in the dark rubber material, and fishing rod steaks have glow in the dark rubber material which is shaped in a “V” shape at the top of the rod steaks.

In a non-limiting embodiment, the tattle tail bobber is rectangular in shape and has a length ranging from about 0.25 inches to about 12.0 inches; a width ranging from about 0.25 inches to about 6.0 inches; and a height ranging from about 0.25 inches to about 6.0 inches. In another embodiment, the rectangular tattle tail bobber length has a length of about 3.0 inches to about 6.0 inches, a width of about 0.5 inches to about 1 inch, and a height of about 0.5 inches to about 1 inch. It should be appreciated, however, that because the invention encompasses tattle tail bobbers having a wide variety of shapes and designs, as described above, these dimensions may vary tremendously as well.

In an embodiment, the weight of the tattle tail bobber ranges from between about 0.1 ounce to about 8.0 pounds. It should be noted that the weight, shape, likeness and design of the tattle tail bobber will depend on the type of fishing the fisher is engaged in, as well as the preferences of the fisher.

The tattle tail bobber device of the present invention in use is as follows. A fishing line is cast into the water. The tattle tail bobber then is placed on the fishing line between two eyelets on the fishing rod. The tattle tail bobber then is pulled downwardly to take out the slack of the fishing line that is in the water. The tattle tail bobber can hang down as far as desired so long as it is suspended above the water, and not resting on or in the water, so that maximum visibility of the fishing line is provided after the fishing line hook is cast in the water. The fisher then waits for a catch of a fish on the hook of the fishing line. When a fish is hooked on the fishing line, the fishing line tightens and the tattle tail bobber moves upwardly towards the fishing rod, which easily can be visualized by a fisher in any light setting, even at night, due to the glow in the dark property of the tattle tail bobber. The ease of visibility of the presence of a fish allows for fishers to catch substantially more fish, because they immediately are alerted to the presence of a fish biting on the bait due to the upward movement of the tattle tail bobber as a result of the increased tension on the fishing line, which allows the fisher to more easily hook the fish. In addition, the use of the tattle tail bobber results in many less fishing poles being lost. This is because a fisher is able to view a catched fish immediately upon its being catched, even when the fisher is not close to or in contact with the fishing rod, due to the visibility of the upward movement of the tattle tail bobber. This immediate alert of a catch allows a fisher to return quickly to the fishing pole. The tattle tail bobber device therefore provides immediate and advance notice of when a fishing line is being pulled so that the fisher is able to pick up the fishing pole before it can be pulled into the water by a fish, and thus lost in the water. In addition, fishers no longer need to use glow sticks, batteries, flashlights and lanterns. Glow sticks typically are placed on top of conventional bobbers that are tossed into water for night visibility.

The advantages of using the tattle tail bobber of the invention to a fisher therefore are numerous. First, the tattle tail bobber does not require batteries or any other type of light source in order to be visible after dark while fishing. The tattle tail bobber also is an excellent device for day time use as well, allowing a fisher freedom to walk away from a fishing rod but still be immediately alerted to a potential catch. Typical alerting mechanisms currently used by fishers include placing a leaf, a piece of Styrofoam or a soda can on a fishing line; all of which still require a light source to be visible after dark. In addition, conventional lighted bobbers placed in the water at night need to use batteries for visual assistance. Further, fishers who fish on the bottom of a water source have to hold their fishing rod, watch the tip of the fishing rod, or lock the fishing rod into a pole holder (which prevents jerking the rod smoothly in order to set the hook in the mouth of a fish). In contrast, the tattle tail bobber of the present invention does not require a fisher to hold the fishing rod, or to sit and stare continuously at the tip of the fishing rod, as the tattle tail bobber is easily visualized from any angle. Still further, the tattle tail bobber of the present invention is relatively small, compact in size, and lightweight, and thus is an excellent training tool for young fishers of all ages to learn how to fish. The tattle tail bobber of the present invention therefore is suitable for fishers of all ages and in all geographic locations.

It will be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

What is claimed is:

1. An alert device for fishing, comprising:
a device referred to as a tattle tail bobber, said tattle tail bobber having a first end and a second end and containing a glow in the dark material; and
a first attachment means attached to the first end and a second attachment means attached to the second end,
wherein the first and the second attachment means each have a curved portion which curves in opposite directions from one another, wherein the first and the second attachment means are configured to accept a fishing line within their curved portions, said fishing line able to slide easily within the opposing curved portions of the first and the second attachment means.

2. The alert device of claim 1, wherein in the tattle tail bobber is suspended above the water.

3. The device of claim 1, wherein in the tattle tail bobber is not buoyant.

4. The device of claim 1, wherein in the tattle tail bobber has a shape selected from the group consisting of ovoid, square, rectangular, cylindrical, round and likenesses of fish, animals, boats, famous landmarks, sports medallions, toys and the like.

5. The device of claim 1, wherein in the glow in the dark material is coated on the tattle tail bobber.

6. The device of claim 1, wherein the glow in the dark material is combined in an injection mold of the device.

7. The device of claim 1, wherein the tattle tail bobber contains a hollow cavity and the glow in the dark material is placed within the cavity.

8. The device of claim 1, wherein the tattle tail bobber can be seen at night without the use of batteries or other light source.

9. The device of claim 1, wherein the tattle tail bobber has a weight ranging from about 0.1 ounce to about 8.0 pounds.

10. The device of claim 1, wherein the tattle tail bobber is manufactured from materials selected from plastics, rubbers and acrylics.

11. An improved method of fishing, comprising:
casting a fishing line into a water source with the use of a fishing rod;
placing a fishing alert device referred to as a tattle tail bobber which contains a glow in the dark material on the fishing line between two eyelets located on the fishing rod;
pulling downwardly on the tattle tail bobber in order to decrease slack of the fishing line, said tattle tail bobber suspended above the water source;
having the tattle tail bobber move upwardly when a fish bites on the fishing line, said upward movement due to the fish pulling downwardly on the fishing line, said downward movement tightening the fishing line; and
a fisher viewing the upwardly moving tattle tail bobber which rapidly alerts the fisher that a fish has bitten on the fishing line, which allows the fisher to react rapidly to hook the fish on the fishing line.

12. The method of claim 11, wherein the fisher is able to view a catched fish immediately upon its being catched even when the fisher is not in contact with or close to the fishing rod.

13. The method of claim 11, wherein in the tattle tail bobber is not buoyant.

14. The method of claim 11, wherein in the tattle tail bobber has a shape selected from the group consisting of ovoid, square, rectangular, cylindrical, round and likenesses of fish, animals or toys.

15. The method of claim 11, wherein in the glow in the dark material is coated on the tattle tail bobber.

16. The method of claim 11, wherein the glow in the dark material is combined in an injection mold of the device.

17. The method of claim 1, wherein the tattle tail bobber contains a hollow cavity and the glow in the dark material is placed within the cavity.

18. The method of claim 11, wherein the tattle tail bobber can be seen at night without the use of batteries or other light source.

19. The method of claim 11, wherein the tattle tail bobber has a weight ranging from about 0. 1 ounce to about 8.0 pounds.

20. The method of claim 11, wherein the tattle tail bobber is manufactured from materials selected from plastics, rubbers and acrylics.
